(19) United States
(12) Patent Application Publication
(10) Pub. No.: US 2012/0266738 A1
(43) Pub. Date: Oct. 25, 2012

(54) MUSIC GAME IMPROVEMENTS

(75) Inventors: David Evans, Adelaide (AU); Doug Hardy, Adelaide (AU); Robert Wolf, Adelaide (AU)

(73) Assignee: STARPLAYIT PTY LTD, Adelaide, South Australia (AU)

(21) Appl. No.: 13/375,015

(22) PCT Filed: May 31, 2010
(86) PCT No.: PCT/AU2010/000670

§ 371 Date: Jul. 6, 2012

(30) Foreign Application Priority Data
Jun. 1, 2009 (AU) 2009902503

(51) Int. Cl. G10H 7/00

(52) U.S. Cl. 84/609

(57) ABSTRACT

The present invention provides a method of processing musical information. A user can perform a musical piece, using a real musical instrument (e.g. a guitar), which is received as audio input. The audio input is then assessed to determine whether it meets various quality standards—for example, whether the user played at the right pitch, at the right time, or at the right volume. If the audio input meets the standards, audio output is then provided of a professional performance of the musical piece, such that it sounds as if the user is performing the professional audio. The standards can be adjusted to different levels, depending on the user's skill on the musical instrument. At an easy level, low standards may be applied, such that even unskilled or beginner musicians can sound like a professional. For more skilled users, the standards may be more difficult to meet. If the user does not meet the quality standards, alternative audio output may be provided, indicating incorrect performance of the musical piece.

### PRIORITY CLAIM

This application claims priority from Australian Patent Application No 2009902503, the entire contents of which are hereby incorporated by reference.

### FIELD OF THE INVENTION

The present invention relates to a method of processing musical information.

### BACKGROUND OF THE INVENTION

The dream of being a rock star is common to many people throughout all walks of life. Music is a popular passion, and the idea of being part of a superstar band, performing to the adulation of a large crowd, provides an obvious thrill. This is a large part of the attraction of karaoke singing performances, and there are associated video games which allow a game player to sing along with popular songs.

Whilst singing is one aspect of a musical performance, people also like to imagine playing a musical instrument as a rock star. Therefore, systems exist which allow the simulation of a person's participation in a concert playing a musical instrument. For example, U.S. Pat. No. 5,990,405 (Auten et al) describes a system whereby a musician can play their instrument (e.g. a guitar) along with a pre-recorded live performance of a song. Audio and video portions of a musical concert are pre-recorded, along with a separate sound track corresponding to the musical instrument (e.g. guitar) played by the musician. As these recordings are played back, the musician can play along with them and hear himself playing in synchronisation with the recordings, thereby simulating participation.

However, one problem with this type of system is that not everyone is able to play a musical instrument at a level that facilitates a satisfying simulation.

Accordingly, other video games exist which allow a user to simulate playing a guitar along with their favourite songs. In these games, the user is provided with a specialised input device, shaped like a guitar, with buttons which they can press in time to the music. Different buttons and button combinations correspond to different notes. The user is shown which buttons to press at what time—if they perform the correct notes at the correct time, a ‘correct’ sound track is played for the guitar, and the virtual audience may cheer or applaud. However, performing incorrect notes may result in a poorer guitar sound track being played, and audience booing or jeering.

Unfortunately, however, there is the problem that the input device is generally formed predominantly of plastic, and requires the pressing of buttons, not strumming of strings. Whilst this is easier (at least at beginner levels) than playing a real guitar, it is also clearly only a ‘fake’ guitar, and so the quality of the simulation is reduced.

### SUMMARY OF THE INVENTION

Accordingly, in a first aspect of the present invention, there is provided a method of processing musical information, comprising:
receiving audio input of a user's performance of a musical piece;
assessing the audio input to determine whether it meets one or more quality standards; and
if the audio input meets the one or more quality standards, providing audio output of a model performance of the musical piece.

The quality standards can take many forms. In a simple form, the assessment may simply test to see whether sound onset is detected at the correct time—no assessment need be made as to note pitch. Therefore, in this case, if the user plays anything at the correct time, they will hear the model performance of the musical piece. Alternative, many criteria may be used—the audio input may be tested to ensure that the correct notes were played in a chord, with the correct pitch, volume and rhythm.

The strictness of the assessment may also vary. At an ‘easy’ level, a wide margin of error is provided—for example, for a pitch criterion at easy level, if the note pitch is somewhat close to correct pitch, within a wide band, the pitch criterion will be met. However, at a more difficult level, the margin of error will be decreased and therefore the acceptable band of pitches will be narrowed.

If the assessment does not meet the one or more quality standards, alternative audio output may be provided. This alternative audio output may vary depending on the criteria that were not met—for example, distinctive ‘wrong’ tones may be played where the user plays a wrong note, or where the user plays at the wrong time. In some embodiments, the alternative audio output could simply be the user's own performance, amplified and played back to them.

The “model” performance corresponds to a high quality performance of the musical piece—for a popular song, it may be a recording of a professional artist playing the relevant part for the user's instrument. Therefore, if a user's performance meets the quality standards, they will sound like “the real thing”—potentially the original artist. If the quality standards are easy to meet, even a beginner can sound like the original artist; however, if the quality standards are difficult to meet, then improved proficiency must be shown.

Additional audio output may also be provided, for other parts of the musical piece—for instance, if a user is playing a guitar, then additional audio output of percussion, bass and vocal parts may be provided, effectively as an accompaniment. This simulates the user playing a part in a band. Crowd noise may also be provided to enhance the simulation.

The audio input will typically be received from an audio input device such as a microphone, which detects sound emitted from a musical instrument such as a guitar, or pickups attached to an electric guitar which provide an audio signal through a guitar lead. However, drums and various other instruments could also be used. By using a real musical instrument (rather than a controller with press buttons), a more realistic simulation is achieved. However, because a user hears a model performance via the audio output, once they meet certain quality standards, it is easier for a beginner to sound like the original artist, which they are likely to find more satisfying.

In a second aspect of the present invention, there is provided a system for processing musical information, comprising:
an audio input device to receive audio input of a user's performance of a musical piece;
a processor to assess the audio input to determine whether it meets one or more quality standards; and
a speaker to provide audio output of a model performance of the musical piece, if the audio input meets the one or more quality standards.

The speaker may be incorporated in headphones, to avoid the listener from hearing sound directly from the user's performance.

In a third aspect of the present invention, there is provided a system for processing musical information, comprising:
audio input means to receive audio input of a musical piece;
assessment means to assess the audio input to determine whether it meets one or more quality standards;
audio out means to provide audio output of a model performance of the musical piece, if the audio input meets the one or more quality standards.

In further aspects of the present invention, there are also provided computer readable media and computer program elements for directing a programmable device to perform the steps of the above method. Yet further aspects of the present invention will be revealed throughout this specification.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 depicts the components of a system according to an embodiment of the present invention;

FIG. 2 is a general diagram of a computer architecture which could be used to implement the present invention;

FIG. 3 is flow chart depicting broadly a method according to an embodiment of the present invention; and

FIG. 4 is a flow chart depicting in more detail the step of assessing the user's performance to determine whether it meets one or more quality standards, in accordance with an embodiment of the present invention.

### DETAILED DESCRIPTION

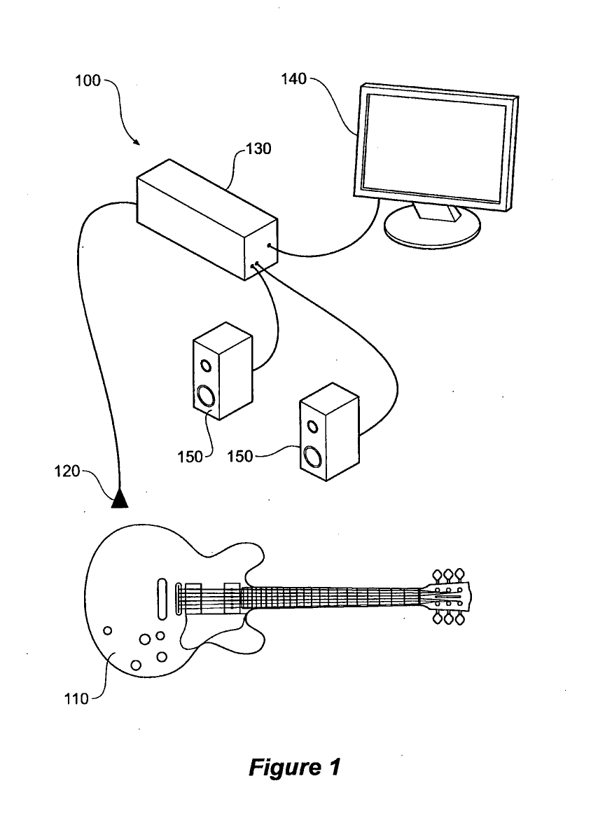

FIG. 1 depicts a system 100 according to an embodiment of the present invention. The system 100 comprises an audio input means, in this case a microphone 120 for receiving audio input from a guitar 110, and an interface device 130. The system 100 also comprises a video screen 140 as well as a pair of speakers 150. In many embodiments, these speakers will be provided using headphones to be worn by the user, to minimise the amount of sound they hear directly from the guitar 110.

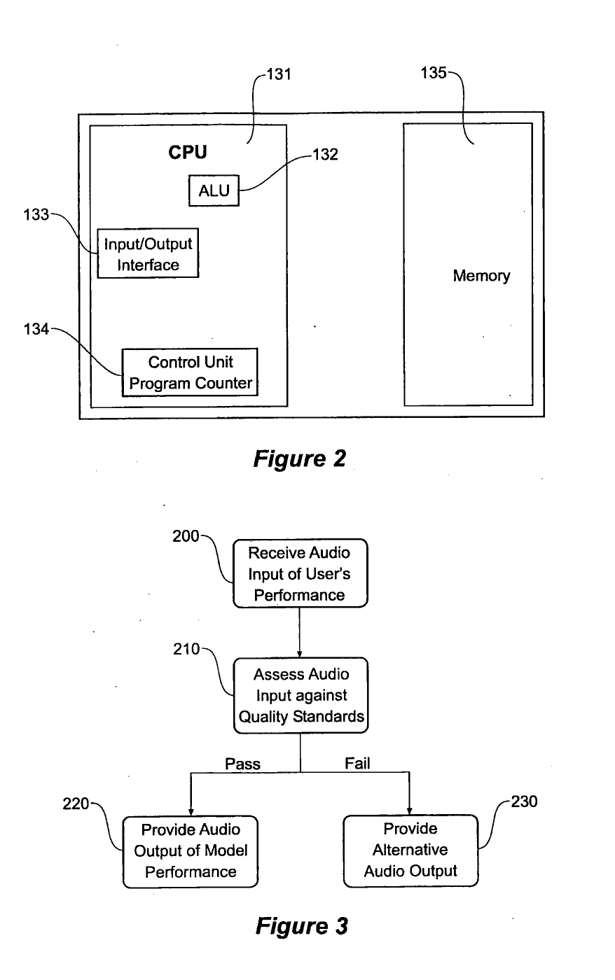

The interface device may be a personal computer. FIG. 2 schematically and generally depicts hardware that may be used in the interface device 130 for implementing the method according to an embodiment of the present invention. A central processing unit (CPU) 131, containing an Input/Output Interface 133, an Arithmetic and Logic Unit (ALU) 132 and a Control Unit and Program Counter element 134 is in communication with input and output devices through the Input/Output Interface 133, and a memory 135.

During operation of this embodiment of the invention, the video screen 140 displays video output of a performance of a musical piece. This video output could be a real performance by a professional band, or it could depict a stylised performance by a cast of different characters (e.g. animated characters).The speakers 150 (for the most part) play the sound of a performance of the musical piece by a professional band. They may also play audio output to be determined in accordance with the present invention.

The video output will typically also show the user what notes/chords they should be playing and when (this may be as little as strumming or picking any note or chord of the user's choice). This may be accomplished by any convenient musical notation system—effectively, any method of displaying musical information may be used in accordance with the present invention. This shows the user what to play and when, allowing them to use the guitar 100 to play their part of the piece along with the professional band.

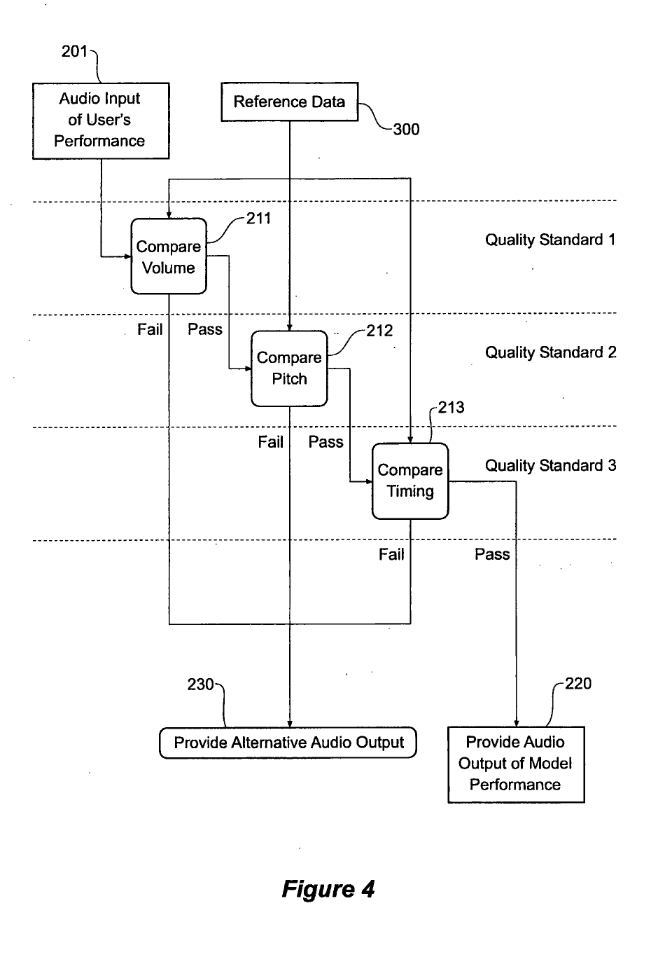

FIGS. 3 and 4 depict a method according to an embodiment of the present invention. First, in step 200. The microphone 120 receives audio input 201 of the user's performance on the guitar 110, and sends it to the processor within the interface device 130. Of course, the audio input device may receive the audio input 201 as an analogue audio signal such as from a pickup on a guitar, or a microphone 120 external to the instrument, which may then be digitised and processed by a sound card, or a digital signal may be provided such as via a MIDI interface.

In broad terms, once the processor receives 200 the audio input 201, it first assesses 210 the quality of the user's performance against predetermined quality standards. Then, depending on the quality of the performance, it determines and provides appropriate audio output 220, 230 to be played back over the speakers 150. If a performance is of sufficient quality, the system will provide audio output of a model performance 220 for their instrument—typically, a recording of the professional band member who plays that instrument in the band. If the performance is not of sufficient quality, an alternative (generally poorer or negative sounding) noise will be provided 230 and played over the speakers 150.

FIG. 4 depicts in more detail one example of the assessment 210 of the audio input 201, implementing three quality standards. It is emphasised that this example is for illustrative purposes only, and the specific implementation of the assessment step 210 may vary widely in different embodiments. In this example, the user's performance is compared 211, 212, 213 to reference data 300—this may be the recording of the model performance itself, or it may be a score of the musical piece provided in any suitable format (e.g. MusicXML). In this example, individual notes or chords may be identified from the audio input 201, and compared to the reference data—note onset can generally be detected by an increase in amplitude (volume) of the audio input 201. This may be a sharp relative increase in amplitude, or it may be detected by monitoring the audio input for a signal e.g. 10 dB above the noise floor.

In FIG. 4, the volume of the audio input 201 is assessed first, to look for note onset. If the volume is below a minimum threshold, or no note onset is detected, then no audio output at all may be played. Otherwise, the volume is compared against the reference data 300, and if the audio input 201 is too loud or too soft, alternative audio output is provided 230 which differs from the model performance (e.g. a distinctive ‘wrong’ tone, or alternatively the model performance may be heavily muted if the user is playing too softly).

If the audio input 201 meets the first standard, the pitch of the audio input 201 is then compared 212 to the reference data 300. If the pitch is not sufficiently close to the pitch prescribed by the reference data 300 (e.g. ±4% of the prescribed frequency), the audio input is deemed to have failed to meet this second quality standard.

The third quality standard relates to the timing of the user's performance, so the audio input 201 is compared 213 to the reference data, to determine whether the timing of the user's performance is accurate—e.g. whether note onset occurred at the timing prescribed by the reference data source 300. If the timing is sufficiently close to the prescribed timing (e.g. ±10 ms), then the audio input is deemed to have met this quality standard. Accordingly, professional audio output is provided 220, and played through the speakers 150, allowing the user to sound like a professional performer.

The number and strictness of the quality standards may be adjusted according to the skill of the user. Accordingly, the system of the present invention may provide a variety of assessment levels. In this embodiment, the audio input may be assessed at “beginner”, “intermediate”, “advanced”, “pro” or master” level. Master level obviously makes the strictest assessment of the quality of the user's performance, and beginner level gives the easiest assessment. With the increase in level, more and more criteria may be used to judge the user's performance, and the success thresholds for each criterion may become higher and higher, i.e. the quality standards become more and more difficult to meet.

At beginner level, in this embodiment, the user's performance is judged to be of sufficient quality if they play anything at all at approximately the time they are supposed to, and the professional audio will be played. However, if the user plays when they are not supposed to, a “bum note” sound will be played. If the user doesn't play when they are supposed to, their part of the performance will be muted. However, whether the user plays or not, all other parts of the band's performance will be played.

Because the standard of assessment is so low at beginner level, in this embodiment, this allows anyone (regardless of their skill or experience with the instrument) to pick up a real instrument and play along with a professional performance. Indeed, the user may have no experience at all, and still be able to pick up a real guitar 110 and sound like the professional guitarist.

Of course, the musical instrument (in this case a guitar 110) is still producing some sound itself, which in the case of an analogue instrument provides the audio input received by the microphone. Therefore, if the user hears himself playing, this may interfere with their simulation experience, particularly if the quality of their playing is poor. To minimise the likelihood of this occurring, the speakers 150 may be incorporated in headphones, or alternatively might be set at a volume level significantly in excess of the volume produced by the guitar 110. One preferred situation is direct input (DI) from an electric guitar via a standard guitar lead, which would address the issue of hearing direct sound from the user's own playing.

In this embodiment, the present invention takes the form of a game that can be played by the user. Accordingly, the user may be assigned a score indicating how well they played. Scoring methods may vary, but in this embodiment, and at beginner level, each time the user plays when they are supposed to, their score will increase, and each time they play at the wrong time (or fail to play at the right time) their score will decrease.

Additional feedback on the user's performance may be displayed on the video screen 140, showing the user when they make a mistake or play a correct note. Audience responses may also be shown on the video screen 40, and potentially played over the speakers 150. The positive or negative strength of audience responses may be calculated based on the most recent portion of the user's performance (e.g. an average of their score for the last twenty notes/chords).

At intermediate level, some musical skill is required to play correct notes or chords. If the user plays approximately the correct notes or chords, at approximately the right time, then professional audio of their part will be played. However, if the user plays the wrong notes or chords, or plays when they are not supposed to, a “bum note” will be played. As in beginner mode, if a user doesn't play at all, their part will be muted. However, regardless of the user's performance, all other parts of the performance will be played over the speakers 150.

Scoring at intermediate level is generous but differentiated. Wrong notes or chords lead to deductions, as does not playing when required or playing during rests in the music. However, good tuning, tone and rhythm are not necessary for a perfect score.

Intermediate level is aimed at guitarists who have a basic knowledge of notes and chords, and allows them to play along using a real guitar, get a good score, and sound generally like a professional guitarist.

At advanced level, more musical skill is required, and so the effect of the simulation is more realistic than at beginner or intermediate level. A user is required to show an understanding of rhythm patterns, which is an additional quality criterion. Their performance will only be judged to be of sufficient quality if the user plays approximately the right notes and chords, at approximately the right time and with approximately the correct rhythm. This will result in the professional audio being played back. As in previous levels, if the user plays when they're not supposed to, a “bum note” sound is played, and if the user doesn't play, their part is muted.

Scoring at advanced level is somewhat forgiving. Wrong notes, chords or rhythm lead to deductions, as does not playing or strumming when required, or playing during rests in the music. However, good tuning and tone are not necessary for a perfect score.

Advanced level is aimed at users who have a basic knowledge of notes and chords as well as rhythm patterns. Such users will be able to play along using a real guitar, get a good score, and sound generally like a professional.

Pro level is the next step up, and requires yet more musical skill. It is aimed at guitarists who have mastered basic notes, chords and strum patterns, and helps the user differentiate between good guitar playing, and not-so-good.

At pro level, if the user plays the correct notes and chords, with the right timing and rhythm, professional audio of their part is played. However, if the notes are out of tune, the recording is pitch shifted up or down accordingly to sound slightly ‘off’. As in previous levels, if the user plays when they're not supposed to, a “bum note” sound is played, and if the user doesn't play, their part is muted.

Scoring at pro level is tougher, but still generally fair. Wrong notes, chords or rhythm lead to deductions, as does not playing or strumming when required, or playing during rests in the music. However, at this level, good tuning is definitely required for a perfect score.

Master level is, of course, the toughest level. It requires an almost professional level of skill. It operates in substantially the same manner as pro level, except that the quality criteria are assessed more strictly, requiring higher standards to be met. If the user plays almost precisely the correct notes and chords, with almost precisely the right timing and rhythm, professional audio of their part is played. However, if the notes are slightly out of tune, the recording is pitch shifted up or down accordingly to sound slightly ‘off’. As in previous levels, if the user plays when they're not supposed to, a “bum note” sound is played, and if the user doesn't play, their part is muted.

Scoring is relatively harsh. Slightly sharp or flat notes, imperfectly strummed chords or loose rhythm lead to deductions, as does not playing or strumming when required, or playing during rests in the music. Virtually perfect tuning and tone are required for a perfect score at master level.

As will be apparent from the preceding description, the expected capabilities of the user increase as the level increases. Accordingly, other features of the game (besides the assessment) may also vary in accordance with the user's expected proficiency.

For example, at higher levels, more sophisticated methods of musical notation may be used to display the required part to the user. Stave notation, tablature, or other specifically designed methods of displaying musical information may be used. At beginner level, however, there may be no need to even display pitch information to the user, since they will not be assessed on it. Accordingly, basic symbols showing when the user should play may be sufficient for the purposes of the game. Of course, some users may prefer to be provided with all the musical information for the required part, so that they can attempt to play their part better. Therefore, the chosen system of displaying the musical information may be varied within the scope of the present invention, or may be customised by the user.

The system may also come with an alternative “artist” mode, where no professional audio is used for the relevant part—instead the system simply acts as a virtual amplifier, and the user's performance is played in its entirety instead of the professional audio. However, even in artist mode, a user may be assigned a score—this may simply be the same as they would have achieved at master level.

The present invention aims to help bridge the gap between music based video games which are limited in their ability to improve refined musicianship, and education music software providing stronger potential for teaching and learning but less entertainment value. The game may be accompanied by a tutorial section, which instructs the user in playing particular musical instruments. This assists them to progress through the levels of the game. Different tutorials may be provided which introduce the concepts for the criteria assessed at each level of the game—i.e. a tutorial may be provided which teaches basic notes and chords, which is suitable for and will provide assistance for a user playing the game at intermediate level.

Although embodiments of the present invention have been described in the foregoing detailed description, it will be understood that the invention is not limited to the embodiment disclosed, but is capable of numerous rearrangements, modifications and substitutions without departing from the scope of the invention. Modifications and variations such as would be apparent to a skilled addressee are deemed within the scope of the present invention.

For example, although the present invention has been described above specifically with reference to user performance using a guitar, different embodiments could be directed to many different instruments, such as percussion instruments or wind instruments.

Furthermore, more or fewer difficulty levels may be used in different embodiments of the present invention. Each level may use a different set of criteria, and/or apply different standards of assessment for each criterion. The assessment levels may vary depending on the preferences and aims of the system designer.

If the user does not meet the quality standards, this may be handled in many different ways, in accordance with the. In some embodiments, no sound may be played at all. In others, a distinctive ‘wrong note’ tone may be played, and in other embodiments the model performance may be pitch shifted, or shifted in timing relative to the audio accompaniment, to reflect the user's mistakes. Many further variations may readily be envisaged by a person skilled in the art.

It will also be understood that a musical composition for a band will have a number of parts, only one of which will generally be performed by a user (e.g. a user playing a guitar will generally perform the guitar part of a composition). To avoid obscuring the features present invention, the detailed description above primarily focuses on the part performed by the user—this part is considered to be the relevant musical piece, and other parts of the composition have been considered as accompaniment to the user's part.

The present invention can also be implemented in numerous ways, including as processes, apparatus, systems, or a computer readable media such as computer readable storage media or computer networks wherein program instructions are sent over optical or electronic communication links.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

1. A method of processing musical information, comprising:
receiving audio input of a user's performance of a musical piece;
assessing the audio input to determine whether it meets one or more quality standards; and
if the audio input meets the one or more quality standards, providing audio output of a model performance of the musical piece.

2. The method of claim 1, further comprising:
if the assessment does not meet the one or more quality standards, providing alternative audio output which differs from the model performance of the musical piece.

3. The method of claim 2, wherein the alternative audio output comprises the audio input of the user's performance.

4. The method of claim 1, wherein the step of assessing comprises comparing the audio input to reference data for the musical piece, and wherein the audio input meets the one or more quality standards if the audio input is sufficiently similar to the reference data.

5. The method of claim 4, wherein one of the one or more quality standards is a pitch standard, and the quality standard is met if the pitch of the audio input is sufficiently similar to the pitch prescribed by the reference data.

6. The method of claim 5, wherein the alternative audio output comprises the model performance shifted in pitch.

7. The method of claim 4, wherein one of the one or more quality standards is a timing standard, and the quality standard is met if the timing of the audio input is sufficiently similar to the timing prescribed by the reference data.

8. The method of claim 7, wherein the alternative audio output comprises the model performance shifted in timing.

9. The method of claim 4, wherein one of the one or more quality standards is a volume standard, and the quality standard is met if the volume of the audio input is sufficiently similar to the volume prescribed by the reference data.

10. The method of claim 4, wherein one of the one or more quality standards is a rhythm standard, and the quality standard is met if the pitch of the audio input is sufficiently similar to the rhythm prescribed by the reference data.

11. The method of claim 1, further comprising adjusting the one or more quality standards to provide a different level of assessment.

12. The method of claim 1, further comprising:
providing additional audio output of an accompaniment to the user's performance.

13. A system for processing musical information, comprising:
an audio input device to receive audio input of a user's performance of a musical piece;
a processor configured to assess the audio input to determine whether it meets one or more quality standards, and, if the audio input meets one or more quality standards, to provide audio output of a model performance of the musical piece; and
a speaker to play the audio output.

14. The system of claim 13, wherein the processor is further configured to provide alternative audio output which differs from the model performance of the musical piece, if the audio input does not meet the one or more quality standards.

15. The system of claim 13, wherein the quality standards are adjustable to provide different levels of assessment.

16. The system of claim 13, further comprising:
a visual display device, to provide visual display output of the musical piece.

17. A system for processing musical information, comprising:
audio input means to receive audio input of a musical piece;
assessment means to assess the audio input to determine whether it meets one or more quality standards;
audio out means to provide audio output of a model performance of the musical piece, if the audio input meets the one or more quality standards.

18. The system of claim 15, wherein the audio output means further provides alternative audio output which differs from the model performance of the musical piece, if the audio input does not meet the one or more quality standards.

19. (canceled)

20. (canceled)
